(19) United States
(12) Patent Application Publication
(10) Pub. No.: US 2025/0077997 A1
(43) Pub. Date: Mar. 6, 2025

(54) COMPREHENSIVE SITE TIMELINE WITH OVERLAY OF INSTALL AND SERVICE ACTIVITIES

(71) Applicant: Tyco Fire & Security GmbH, Neuhausen am Rheinfall (CH)

(72) Inventors: Joseph Morris, Monsey, NY (US); Matthew P. Kaiser, Milwaukee, WI (US); Michael J. Zummo, Milwaukee, WI (US)

(73) Assignee: Tyco Fire & Security GmbH, Neuhausen am Rheinfall (CH)

(21) Appl. No.: 18/817,055

(22) Filed: Aug. 27, 2024

Related U.S. Application Data
(60) Provisional application No. 63/535,021, filed on Aug. 28, 2023.

(51) Int. Cl. G06Q 10/0631; G06Q 10/20

(52) U.S. Cl. CPC G06Q 10/063114; G06Q 10/20

(57) ABSTRACT

A method comprising receiving data relating to a building site from a plurality of separate building applications, aggregating the received data from the plurality of separate building applications in accordance with a predetermined format, where the aggregated data represents a plurality of events associated with the building site over a lifecycle of the building site, filtering the aggregated data to identify a plurality of isolated events associated with the building site over the lifecycle of the building site, where each of the plurality of isolated events includes a time associated with the isolated event, generating a timeline comprising the plurality of isolated events, wherein the timeline is arranged based on the time associated with each isolated event, and providing the timeline on a graphical user interface, where each of the plurality of isolated events includes an event marker on the timeline representative of the isolated event.

### CROSS-REFERENCE TO RELATED APPLICATIONS

This application claims the benefit of and priority to U.S. Provisional Application No. 63/535,021, filed Aug. 28, 2023, the entire disclosure of which is incorporated by reference herein.

### BACKGROUND

The present disclosure relates generally to building management systems. The present disclosure relates more particularly to systems and methods for presenting data and information relating to historical events and the associated health and performance of a building site.

A building management system (BMS) is, in general, a system of devices configured to control, monitor, and manage equipment in or around a building or building area. A BMS can include a heating, ventilation, and air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include a variety of devices (e.g., HVAC devices, controllers, chillers, fans, sensors, etc.) configured to facilitate monitoring and controlling the building space. Throughout this disclosure, such devices are referred to as BMS devices or building equipment.

Currently, many building management systems provide control of an entire facility, building, or other environment. The building management system may control HVAC systems, water system, lights, air quality, security, and/or any other aspect of the facility within the purview of the building management system. These systems may require skilled persons to adjust, control, and otherwise operate the building management system, due to the complexity. In large facilities or buildings, this management can be labor intensive. Moreover, in buildings where dynamic management of the building management system is required (i.e. buildings with multiple independent HVAC requirements), advanced control strategies may be required along with ongoing preventative maintenance of individual systems within the building management system to adjust for the dynamic use of the building or facility.

Once a BMS system is commissioned and operational at a user site, the generally large size of BMS systems makes verification and assessment of the system's performance difficult. Obtaining performance information regarding the BMS system can be critical in determining if the BMS system is functioning as per its specified design. This information may provide useful insights into the BMS system, as well as the overall health and performance of a building or components at a building site. Furthermore, as systems change over time, it is important to monitor and understand how the changes affect the health and/or performance of components or systems of the BMS system, of the building site as a whole. Thus, it would be advantageous to have a tool available that could easily and efficiently receive data relating to historic events associated with a building site, and provide the information in a coherent and easily understandable manner, for example to evaluate the health and/or performance of a building site and/or offer suggestions or recommendations for increasing the health or performance of components of a building site, or the building as a whole.

### SUMMARY

At least one embodiment relates to a method. The method includes receiving data relating to a building site from a plurality of separate building applications, and aggregating the received data from the plurality of separate building applications in accordance with a predetermined format, where the aggregated data represents a plurality of events associated with the building site over a lifecycle of the building site. The method further includes filtering the aggregated data to identify a plurality of isolated events associated with the building site over the lifecycle of the building site, where each of the plurality of isolated events includes a time associated with the isolated event, and generating a timeline comprising the plurality of isolated events, wherein the timeline is arranged based on the time associated with each isolated event. The method further includes providing the timeline on a graphical user interface, where each of the plurality of isolated events includes an event marker on the timeline representative of the isolated event.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a is a drawing of a building equipped with a building management system (BMS) and a HVAC system, according to some embodiments.

FIG. 2 is a schematic of a waterside system which can be used as part of the HVAC system of FIG. 1, according to some embodiments.

FIG. 3 is a block diagram of an airside system which can be used as part of the HVAC system of FIG. 1, according to some embodiments.

FIG. 4 is a block diagram of a BMS which can be used in the building of FIG. 1, according to some embodiments.

FIG. 5 is a block diagram illustrating a site directory tool, according to some embodiments.

FIG. 6 is a flow chart illustrating a process for a site directory workflow, according to some embodiments.

FIG. 7 is a screen shot illustrating an example site timeline interface having a site timeline, according to some embodiments.

FIG. 8 is a screen shot illustrating an example site timeline interface having a selected time range, according to some embodiments.

FIG. 9 is a screen shot illustrating an example site timeline interface having health-related information, according to some embodiments.

FIG. 10 is a screen shot illustrating an example site timeline interface having health-related information, according to some embodiments.

FIG. 11 is a screen shot illustrating an example site timeline interface having topic information, according to some embodiments.

FIG. 12 is a screen shot illustrating an example site timeline interface having an adjustment feature, according to some embodiments.

FIG. 13 is a screen shot illustrating an example site timeline interface having an adjusted timeline, according to some embodiments.

FIG. 14 is a screen shot illustrating an example site timeline interface having project information, according to some embodiments.

FIG. 15 is a screen shot illustrating an example site timeline interface having project information, according to some embodiments.

FIG. 16 is a screen shot illustrating an example recommendation interface having recommendation information, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Building Management System and HVAC System

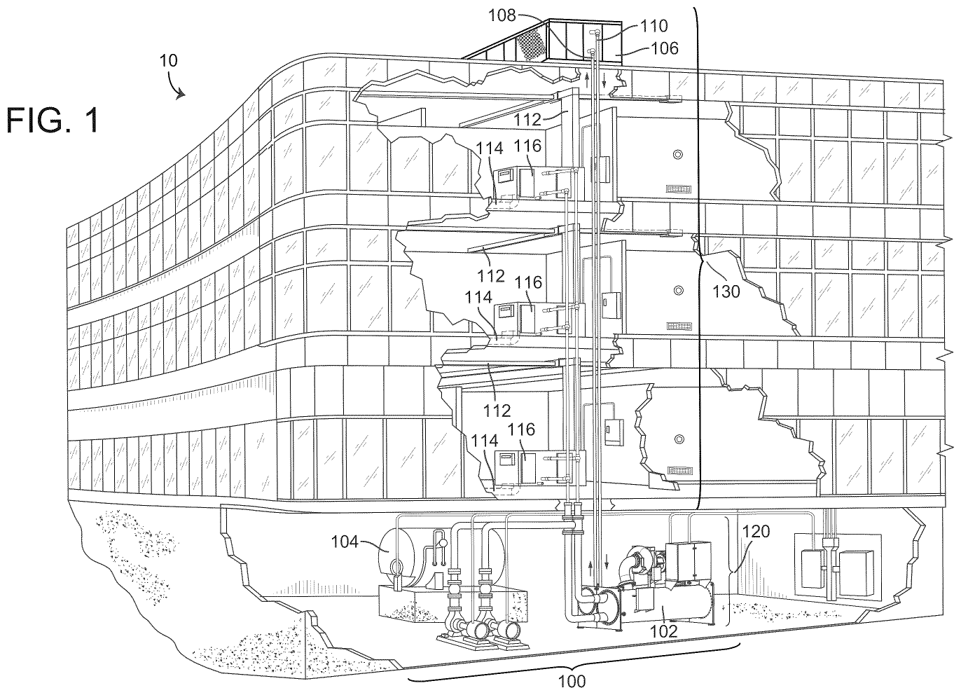

Referring now to FIGS. 1-4, an exemplary building management system (BMS) and HVAC system in which the systems and methods of the present disclosure can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

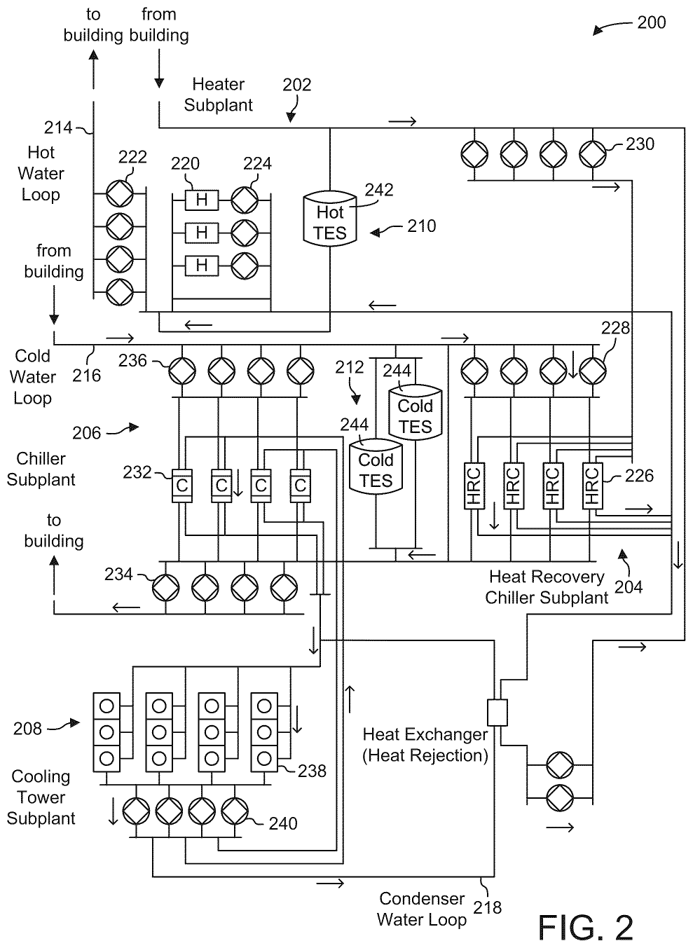

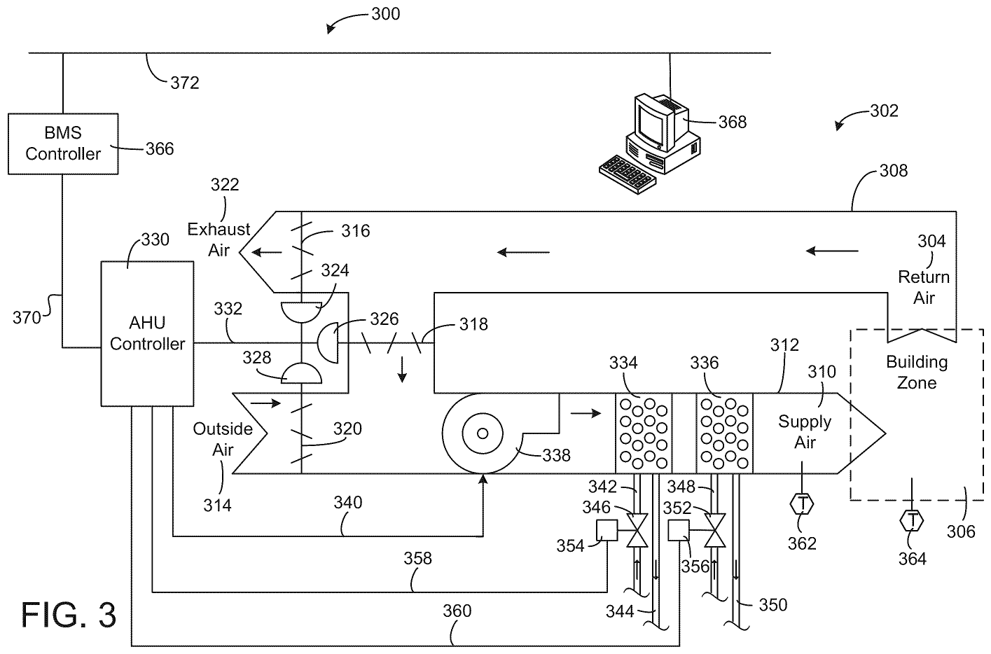

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve set-point conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive Agenth return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a set-point temperature for supply air 310 or to maintain the temperature of supply air 310 within a set-point temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of Agenth.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

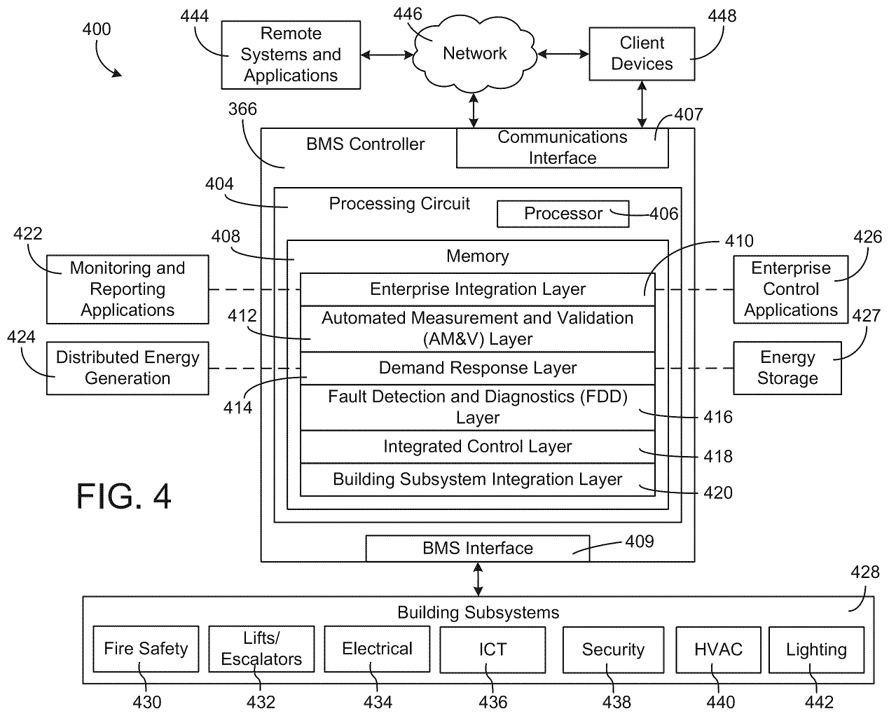

Referring now to FIG. 4, a block diagram of a building management system (BMS) 400 is shown, according to an exemplary embodiment. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or Agenth of interfaces 407, 409 can include cellular or mobile phone communications transceivers. In one embodiment, communications interface 407 is a power line communications interface and BMS interface 409 is an Ethernet interface. In other embodiments, Agenth communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand set-point before returning to a normally scheduled set-point, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the set-point for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include set-point or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its set-point. These processes can be examined by FDD layer 416 to expose when the system begins to degrade in performance and alert a user to repair the fault before it becomes more severe.

### Site Directory Tool

The BMS, as described above, has multiple individual components within the BMS. Example components may include control devices, such as field equipment controllers (FECs), advanced application field equipment controllers (FAC), network control engines (NCEs), input/output modules (IOMs), and variable air volume (VAV) modular assemblies. However, other control device types are contemplated. Further, the BMS may include equipment such as actuators, valves, AHUs, RTUs, thermostats, or any other device associated with the BMS, which are controlled by the control devices described above. In some examples, these devices may be monitored using a centralized monitoring tool, such as a controller configuration tool (CCT) from Johnson Controls. However, other monitoring tools are contemplated.

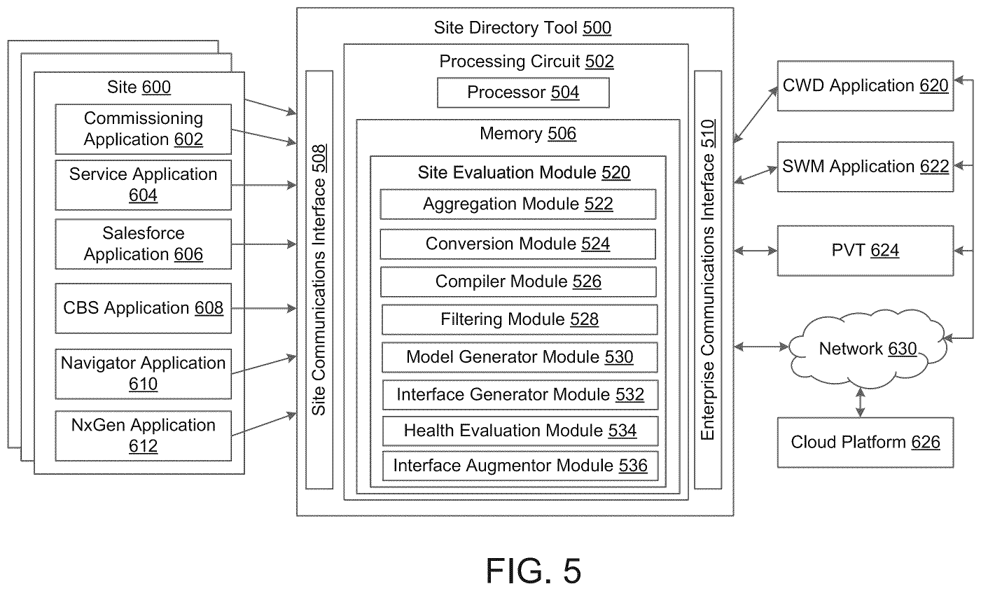

Referring now to FIG. 5, a block diagram showing a site directory tool 500 is provided, according to some embodiments. The site directory tool 500 is shown to include a processing circuit 502. The processing circuit 502 includes a processor and a memory 506. The site directory tool 500 may also include one or more communication interfaces, shown as site communications interface 508 and enterprise communications interface 510. The communications interfaces 508, 510 may be application programming interfaces, or any suitable communications interface to facilitate the communication of information (e.g., data, etc.) between the site directory tool 500 and one or more applications, devices, and/or systems. The processor 504 may be a general purpose or specific purpose processor, an application specific integrated circuit (ASIC), one or more field programmable gate arrays (FPGAs), a group of processing components, or other suitable processing components. The processor 504 may be configured to execute computer code or instructions stored in the memory 506 or received from other computer readable media (e.g., CDROM, network storage, a remote server, etc.).

The memory 506 may include one or more devices (e.g., memory units, memory devices, storage devices, etc.) for storing data and/or computer code for completing and/or facilitating the various processes described in the present disclosure. The memory 506 may include random access memory (RAM), read-only memory (ROM), hard drive storage, temporary storage, non-volatile memory, flash memory, optical memory, or any other suitable memory for storing software objects and/or computer instructions. The memory 506 may include database components, object code components, script components, or any other type of information structure for supporting the various activities and information structures described in the present disclosure. The memory 506 may be communicably connected to the processor 504 via processing circuit 502 and may include computer code for executing (e.g., by processor 504) one or more processes described herein.

The memory 506 may include a site evaluation module 520. The site evaluation module 520 may include a number of additional modules, for example an aggregation module 522, a conversion module 524, a compiler module 526, a filtering module 528, a model generator module 530, an interface generator module 532, a health evaluation module 534, and/or an interface augmentor module 536. As will be discussed in greater detail below, in an exemplary embodiment the site evaluation module 520 is configured to receive data from one or more sources (e.g., systems or applications having disparate or different data formats, etc.), aggregate and unify the data, and provide one or more interfaces that are viewable to a user or operator, for example to provide information relating to events associated with the health and/or performance of a site. Advantageously, the site evaluation module 520 is capable of receiving data from one or more different data sources (e.g., salesforce applications, business solution applications, solutions navigator applications, software licensing applications, etc.), aggregate the data from the data sources (e.g., historical data, etc.), unify the data into a unified format, and/or provide the data in one or more interfaces that allow a user to easily view and/or assess events associated with the health and/or performance of a building site.

As shown in FIG. 5, the site directory tool 500 is configured to receive site data from a building site, shown as site 600 (e.g., via the site communications interface 508). The site 600 may be one of a plurality of sites 600, which may be any suitable type of building, location, or site (e.g., factories, office building, colleges or universities, hospitals, etc.). According to an exemplary embodiment, the site data includes a unique identifier identifying each specific site 600. For example, the unique identifier may be a unique code (e.g., an alphanumeric string) identifying each specific site 600, which may be in a format that is the same or different between different sites 600. As will be discussed in greater detail below, the site evaluation module 520 may be configured to receive site data (e.g., unique identifiers from a plurality of sites 600), and convert the data into a unified format, for example to associate a unified unique identifier with each specific site 600.

In some embodiments, the site data also includes historical site data relating to the site 600. For example, the site data may include information relating to initial construction (e.g., date, time, place, etc.), initial commissioning (e.g., date, time, place, etc.), historical construction events (e.g., additions, renovations, demolitions, etc.), historical modifications (e.g., building device replacement, etc.), and/or any other suitable data relating to the site 600. In this regard, the site data (e.g., historical site data) may allow a reviewer to assess historical events associated with a site since the site originated. In some embodiments, this historical site data is in a disparate or different format (e.g., different alphanumeric string, code, coding language, etc.) from the unique site identifier. In an exemplary embodiment, the site evaluation module 520 is configured to receive the historical site data, associate the historical site data with the associated site 600 (e.g., associate the historical site data with the appropriate unique identifier, etc.), aggregate the historical site data, and convert the data to a unified format, for example to provide unified historical site data associated with each specific site 600.

As shown, in some embodiments each site 600 is associated with one or more services or features. For example, each site 600 may utilize commissioning and/or maintenance services, fault detection services, salesforce service, customized business solution services, computer or software services, etc. Each of these services or features may further be associated with a related device, computing system, software, application, etc. Further, each of these services or features may be configured to communicate information (e.g., data) associated with the services or features, for example to the site evaluation module 520. As indicated above, and as will be discussed in greater detail below, each service or feature associated with a site 600 may be configured to communicate information (e.g., data) in disparate or different formats. The site evaluation module 520 may be configured to receive this data (e.g., in different data formats, etc.), associate the data with the appropriate associated site 600, aggregate the data associated with each site 600, and/or convert the data to a unified format, for example for subsequent analysis and/or processing.

According to an exemplary embodiment, the site 600 includes a commissioning application 602. The commissioning application 602 may be configured to communicate commissioning data (e.g., relating to an associated site 600) to the site evaluation module 520 (e.g., via the site communications interface 508). Commissioning data may include information relating to initial commissioning (e.g., date, time, commissioning events, commissioning results, etc.), historical commissioning events (e.g., data, time, events, results, etc.), and/or other information relating to commissioning events or procedures. In some embodiments, the site includes a service application 604. The service application 604 may be configured to communicate service or maintenance data (e.g., relating to an associated site 600) to the site evaluation module 520 (e.g., via the site communications interface 508). The service or maintenance data may include information relating to historical maintenance events (e.g., date, time, location, maintenance performed, device or system maintenance was performed on, etc.) and/or any other suitable information relating to service or maintenance procedures.

In an exemplary embodiment, the site 600 also includes a salesforce application 606. The salesforce application 606 may be configured to communicate sales data (e.g., relating to an associated site 600) to the site evaluation module 520 (e.g., via the site communications interface 508). The sales data may include information relating to the salesforce or sales team (e.g., services used, number of personnel, personnel information, etc.), historic sales information (e.g., time and/or date of sales transactions, historic sales numbers, device or component sales, etc.), and/or any other suitable information relating to sales or the salesforce. In some embodiments, the site 600 also includes a business solutions application, shown as CBS application 608. The CBS application 608 may be configured to communicate business data to the site evaluation module 520 (e.g., via the site communications interface 508). The business data may include historical information relating to customers (e.g., names, locations, size, etc.), historical information relating to customer contracts (e.g., existing contracts, prior contracts, etc.), historical information relating to business transactions (e.g., times, dates, purchases, orders, etc.), and/or any other suitable information relating to customers or associated businesses.

In an exemplary embodiment, the site 600 also includes a navigator or solutions navigator application, shown as navigator application 610. The navigator application 610 may be configured to communicate installation data (e.g., relating to an associated site 600) to the site evaluation module 520 (e.g., via the site communications interface 508). The installation data may include information relating to device or component selection (e.g., component type, configuration, make, model, etc.), device or component ordering (e.g., date, time, manufacturer, provider, etc.), and/or any other suitable information relating to installation of one or more devices or components (e.g., at the site 600). In some embodiments, the site 600 includes a next generation application, shown as NxGen application 612. The NxGen application 612 may be configured to communicate service data (e.g., relating to an associated site 600) to the site evaluation module 520 (e.g., via the site communications interface 508). For example, the service data may include information from a third-party service provider (e.g., technician) relating to historical service or maintenance events (e.g., date, time, location, maintenance performed, device or system maintenance was performed on, etc.) and/or any other suitable information relating to service procedures.

As shown in FIG. 5, the site directory tool 500 is also configured to communicate (e.g., information, data, etc.) with one or more enterprise applications. For example, the site directory tool 500 may be configured to communicate (e.g., data) with a workflow dashboard application, shown as CWD application 620. The CWD application 620 may be configured to communicate workflow data (e.g., relating to an associated site 600) to the site evaluation module 520 (e.g., via the enterprise communications interface 510). Workflow data may include information relating to installation, commissioning, setup procedures or events (e.g., date, time, location, procedures performed by a technician or service provider, etc.), and/or any other suitable workflow data. In some embodiments, the site directory tool 500 is configured to communicate with a software monetization application, shown as SWM application 622. The SWM application 622 may be configured to communicate software data (e.g., relating to an associated site 600) to the site evaluation module 520 (e.g., via the enterprise communications interface 510). Software data may include information relating to one or more software licenses (e.g., existing customer licenses, type of software license, etc.), one or more available software licenses or services (e.g., available software upgrades, available software services, etc.), sales and/or pricing information associated with software licenses, and/or any other suitable information relating to software licenses or associated services.

In an exemplary embodiment, the site directory tool 500 is also configured to communicate (e.g., data) with an evaluation or verification tool, shown as performance verification tool (PVT) 624. The PVT 624 may be configured to communicate performance data (e.g., relating to an associated site 600) to the site evaluation module 520 (e.g., via the enterprise communications interface 510). Performance data may include information relating to operation or performance of a building management system (e.g., performance reports relating to a system or subsystem, etc.), information relating to components or devices at the BMS (e.g., performance reports relating to pieces of building equipment, etc.), statuses of one or more components or devices (e.g., software versions, available software upgrades, memory or storage usage or availability, etc.), and/or any other suitable information relating to characteristics or performance of a building management system. The features and/or functions of the PVT (e.g., the PVT 624) may be as described in U.S. patent application Ser. No. 18/215,453, filed Jun. 28, 2023, the entire disclosure of which is incorporated by reference herein. Further, the features and/or functions of the PVT (e.g., the PVT 624) may be as described in U.S. patent application Ser. No. 18/215,760, filed Jun. 28, 2023, the entire disclosure of which is incorporated by reference herein.

In some embodiments, the site directory tool 500 is also configured to communicate with a cloud platform 626, for example via a network 630. The network 630 can communicatively couple devices and/or systems, for example site directory tool 500, the CWD application 620, the SWM application 622, the PVT 624, and/or the cloud platform 626. In some embodiments, the network 630 is at least one of and/or a combination of a Wi-Fi network, a wired Ethernet network, a ZigBee network, a Bluetooth network, and/or any other wireless network. The network 630 may be a local area network or a wide area network (e.g., the Internet, a building WAN, etc.) and may use a variety of communications protocols (e.g., BACnet, IP, LON, etc.). The network 630 may include routers, modems, servers, cell towers, satellites, and/or network switches. The network 630 may be a combination of wired and wireless networks.

As indicated above, in some embodiments the information (e.g., data) communicated to/from the applications 602-626 are in disparate or different formats. For example, each application 602-626 may utilize a data format that includes different site identifiers, different software or coding language (e.g., rules, logic, etc.), and/or different data formats. Further, in some embodiments the information (e.g., data) communicated from the applications 602-626 are not associated with other applications, for example other applications used at one or more of the sites 600. In this regard, the information (e.g., data) received at the site evaluation module 520 may be in different formats (e.g., different site identifiers, etc.) and/or segmented, such that the site evaluation module 520 may receive groups of data associated with a site 600 that appear different and/or isolated.

Referring still to FIG. 5, the site evaluation module 520 is shown to include one or more additional modules. For example, the site evaluation module 520 may include an aggregation module 522, a conversion module 524, a compiler module 526, a filtering module 528, a model generator module 530, an interface generator module 532, a health evaluation module 534, and/or an interface augmentor module 536. According to an exemplary embodiment, components of the site evaluation module 520 (e.g., modules 522-536, etc.) are configured to receive data from one or more sources (e.g., applications 602-626, etc.), aggregate and unify the data, and provide one or more interfaces that are viewable to a user or operator, for example to allow a user to easily view and/or assess one or more events and/or the heath or performance of a building site.

As indicated above, in an exemplary embodiment the site evaluation module 520 is configured to receive data from one or more sources. For example, the site evaluation module 520 may receive site data associated with a site 600, commissioning data from the commissioning application 602, service data from the service application 604, salesforce data from the salesforce application 606, and/or any other data or information discussed herein. As discussed above, in some embodiments the data is in different data formats and/or is segmented or isolated, for example based on the source application (e.g., applications 602-626, etc.).

In an exemplary embodiment, the aggregation module 522 is configured to aggregate the data received from the one or more sources. For example, the aggregation module 522 may be configured to aggregate (e.g., combine, group, etc.) data from the one or more sources (e.g., applications 602-626, etc.) for each individual site (e.g., the site 600). In some embodiments, the aggregation module 522 is configured to generate a table or index the data for each site 600 and/or populate the table with data aggregated from the one or more sources (e.g., applications 602-626, etc.). In this regard, the aggregation module 522 may be configured to combine the data associated with a site (e.g., each of the sites 600, etc.) into an easy to navigate (e.g., searchable, viewable, etc.) data table or format.

In an exemplary embodiment, the conversion module 524 is configured to convert the data received from the one or more sources into a unified (e.g., uniform, etc.) format. For example, after the aggregation module 522 aggregates the data for each individual site, the conversion module 524 may be configured to convert the data (e.g., different data formats from the applications 602-626, etc.) into a unified or uniform format. For example, the conversion module 524 may be configured to convert the different site identifiers received/used by the applications 602-626 into a unified site identifier (e.g., based on one or more conversion rules, etc.), which uniquely identifies each site 600 to the site directory tool 500. Similarly, the conversion module 524 may be configured to convert the site data (e.g., associated with a site 600), the commissioning data (e.g., from the commissioning application 602), the service data (e.g., from the service application 604), and/or the other data described herein into a unified data format that is identifiable to the site directory tool 500. In an exemplary embodiment, the conversion module 524 is configured to convert the aggregated data based one or more conversion rules or logic.

In an exemplary embodiment, the compiler module 526 is configured to compile the data received from the one or more sources. For example, after the aggregation module 522 aggregates the data for each individual site 600 (and/or the conversion module 524 converts the aggregated data into a unified format), the compiler module 526 may be configured to compile (e.g., arrange, organize, etc.) the data. In an exemplary embodiment, the compiler module 526 is configured to compile (e.g., arrange, organize, etc.) the data for each individual site 600 in an accordance with a format or rule (e.g., chronological order, etc.). For example, the compiler module 526 may be configured to compile the commissioning data, service data, salesforce data, etc. (e.g., the aggregated data, etc.), and arrange the data for each individual site 600 in chronological order. In this regard, the compiler module 526 may be configured to arrange data associated with each individual site 600, such that the data provides a chronological timeline of events associated with each individual site 600. In some embodiments, the compiler module 526 is configured to compile (e.g., organize, arrange, etc.) the data associated with each individual site 600 based on one or more rules or hierarchies. For example, in some embodiments the compiler module 526 is configured to arrange the data associated with each site based on the type of faults detected, severity of adverse or associated events, and/or based on a hierarchy of events or services at each site 600.

In an exemplary embodiment, the filtering module 528 is configured to filter the data received from the one or more sources. For example, after the data is compiled by the compiler module 526 (e.g., arranged in chronological order for each site 600, etc.), the filtering module 528 may be configured to filter the compiled data, for example to remove or obscure certain pieces of information and/or to identify or highlight other pieces of information. In some embodiments, the filtering module 528 is configured to filter the data using any number and/or type of artificial intelligence (AI), machine learning (ML), and/or mathematical models, which may be used to assess the performance of a building or a building design. For example, the filtering module 528 (e.g., via the AI, ML, mathematical models, etc.) may be configured to filter the compiled data, for example to identify certain points along the timeline that could pose a potential fault or issue, and/or that resulted in a fault or failure event. In this regard, the components of the filtering module 528 may be configured to filter the compiled data to identify relevant events (e.g., fault conditions, potential fault conditions, adverse events, potential adverse events, etc.) thereby allowing a user or operator to easily and quickly assess issues associated with identified events and/or the performance or health of a building site 600.

In some embodiments, the site evaluation module 520 further includes a model generator module 530. In an exemplary embodiment, the model generator module 530 is configured to analyze the compiled data (and/or the filtered data) and generate one or more models and/or data points along the timeline of an associated site 600. The model generator module 530 may be configured to generate the one or more points using any number and/or type of artificial intelligence (AI), machine learning (ML), and/or mathematical models. The points may be based on model characteristics of components and/or devices at a site 600 and may represent gap-filling events (e.g., services, events, etc.) that may have occurred along the timeline of the site 600. In this regard, the model generator module 530 may be configured to analyze the data from the one or more sources (e.g., via AI, ML, mathematical models, etc.), and/or provide additional data points (e.g., events, services, etc.) along the timeline of the site, to provide a more complete set of information surrounding events associated with the history of the site. In some embodiments, the additional data points (e.g., events, services, etc.) are provided along the timeline with a prompt or different indicator, for example to receive approval prior to inclusion in the timeline.

As shown in FIG. 5, the site evaluation module 520 further includes an interface generator module 532. According to an exemplary embodiment, the interface generator module 532 is configured to generate one or more interfaces (e.g., graphical interfaces, user interfaces, etc.), for example relating to events associated with the health and/or performance of a site 600. In an exemplary embodiment, the interface generator module 532 is configured to receive data from components of the site evaluation module 520 (e.g., modules 522-530), and generate one or more interfaces illustrating the data using one or more indicators, labels, values, and/or displays. For example, the interface generator module 532 may be configured to generate one or more interfaces that illustrate a timeline associated with events relating to the health and/or performance of a site 600. The interface generator module 532 may be configured to communicate the one or more interfaces to one or more external or related devices (e.g., a user device, a computing device, etc. via the communications interfaces 508, 510, etc.), for example to be displayed and/or communicated to a user or operator. In an exemplary embodiment, a user or operator can interact with the one or more interfaces (e.g., manipulate, alter, modify, etc.), for example to provide one or more user inputs to the site evaluation module 520. In some embodiments, in response to the one or more user inputs, the interface generator module 532 is configured to modify (e.g., update, etc.) the one or more interfaces and/or generate one or more additional interfaces. In this regard, the interface generator module 532 may be configured to generate a series of interfaces, which a user or operator can interact with, fore example to provide a series of interfaces that allow a user to easily view and assess features associated with events relating to the health and/or performance of a site 600, as will be discussed below.

According to an exemplary embodiment, the site evaluation module 520 further includes a health evaluation module 534. According to an exemplary embodiment, the health evaluation module 534 is configured to receive data from components of the site evaluation module 520 (e.g., modules 522-530), and determine one or more characteristics associated with a health of the associated site 600. For example, the health evaluation module 534 may be configured to receive data (e.g., aggregated, filtered, compiled data, etc.) from components of the site evaluation module 520, and determine characteristics relating to an overall health of an associated site 600. In some embodiments, the health evaluation module 534 is configured to determine the impact of identified or isolated events (e.g., relevant events, etc.) on the health of an associated component and/or the overall health of an associated site 600. The health evaluation module 534 may be configured to categorize the characteristics associated with the health, for example based on severity (e.g., low, medium, high, etc.), impact on the health of the site 600 (e.g., low, medium, high, etc.), and/or based on the type of the event or service. The health evaluation module 534 may be configured to communicate the health-related data (e.g., characteristic data, etc.) to other components of the site evaluation module 520 (e.g., the interface generator module 532, an interface augmentor module, etc.), for example to be displayed on one or more interfaces for review and/or analysis by a user or operator.

In some embodiments, the site evaluation module 520 further includes an interface augmentor module 536. According to an exemplary embodiment, the interface augmentor module 536 is configured to generate and/or provide one or more interfaces, for example to augment or supplement one or more interfaces (e.g., a preceding interface, etc.). For example, as discussed above the interface generator module 532 may be configured to generate one or more interfaces, which may receive one or more user interactions (e.g., inputs, etc.). The interface augmentor module 536 may be configured to receive the inputs associated with the interfaces and generate one or more augmented or supplemental interfaces based on the inputs. In some embodiments, the supplemental interfaces include additional indicators, labels, values, and/or displays, for example relating to one or more events associated with a health and/or performance of a site 600. In some embodiments, the interface generator module 532 and the interface augmentor module 536 are a single module, for example to generate one or more interfaces that are viewable by a user or operator to easily assess events associated with a health and/or performance at a site 600.

It should be understood that while components of the site evaluation module 520 are described herein as having certain features and/or performing certain functions, it is contemplated that the site evaluation module 520 may include additional, fewer, and/or different working components configured to perform any or all of the operations described herein. Further, it should be understood that it is contemplated that any or all of the features and/or functions of the site evaluation module 520 may be performed in any order, any number of steps, and/or any combination of steps.

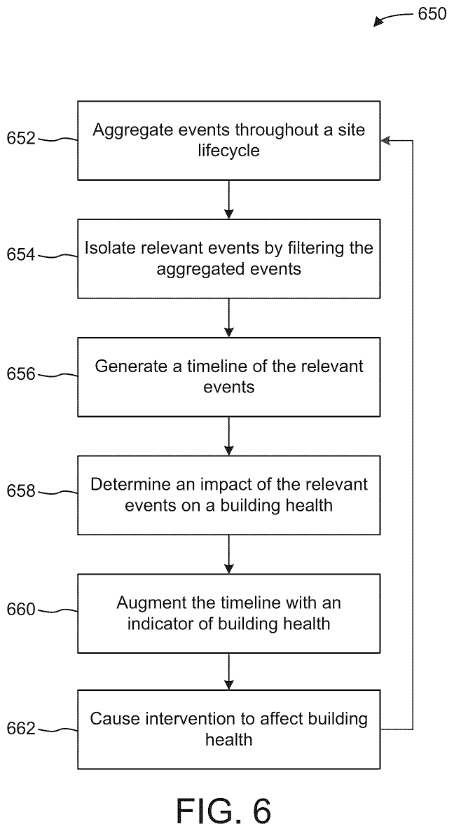

Referring now to FIG. 6, a site directory workflow 650 for analyzing and providing information relating to events associated with the health and performance of a site is shown, according to an exemplary embodiment. In an exemplary embodiment, the workflow 650 may be implemented using one or more components of the site directory tool 500 of FIG. 5, and/or the associated applications (e.g., applications 602-626) and systems. As discussed above, in an exemplary embodiment the site directory tool 500 is configured to receive information (e.g., data) from one or more sources (e.g., applications 602-626). In some embodiments, the information and/or data is provided in one or more different formats, and/or is received in isolated or segmented groups.

According to an exemplary embodiment, the workflow 650 includes aggregating data associated with a site, shown as aggregating events throughout a site lifecycle at step 652. For example, the aggregation module 522 may be configured to aggregate (e.g., combine, group, etc.) data from the one or more sources (e.g., applications 602-626, etc.) for each individual site or building site (e.g., the site 600). In an exemplary embodiment, the data includes historical data relating to the site, for example data throughout the lifecycle of the site. In some embodiments, the aggregation data is stored in a table or indexed in accordance with a predefined format, for example such that the data is easily searchable and/or reviewable.

In some embodiments, the workflow 650 also includes converting the aggregated data into a unified or uniform format. For example, the conversion module 524 may be configured to convert the aggregated data into a unified or uniform format, for example based on one or more conversion rules or logic. In other embodiments, the workflow 650 further includes compiling (e.g., arranging, organizing, etc.) the aggregated data in accordance with one or more rules or formats. For example, the compiler module 526 may be configured to compile (e.g., arrange, organize, etc.) the aggregated (and/or unified) data in chronological order. In yet other embodiments, the aggregation module 522 is configured to aggregate, convert, and/or compile the data received from the one or more sources.

According to an exemplary embodiment, the workflow 650 includes isolating data by filtering the aggregated data, shown as isolating relevant events by filtering the aggregated events at step 654. For example, the filtering module 528 maybe configured to filter the aggregated data to identify certain relevant events and/or services throughout the lifecycle of the site 600. In an exemplary embodiment, the filtering module 528 is configured to filter the aggregated data (e.g., via the AI, ML, mathematical models, etc.). In some embodiments, the relevant events relate to points along the timeline (e.g., lifecycle of the site 600), which represent potential fault or failure events, and/or that resulted in a fault or failure event. In other embodiments, the relevant events relate to points along the timeline (e.g., lifecycle of the site 600) associated with one or more services or available services, one or more updates or changes to the services or available service (e.g., updates, upgrades, etc.), one or more occurrences or incidents at the site 600 (e.g., new or different device detected at the site 600, commissioning event occurred at the site 600, etc.), and/or other events, services, or features associated with the site 600. In this regard, the filtering module 528 may be configured to analyze the aggregated data (and/or the converted and/or compiled data, etc.) to remove and/or obscure certain information (e.g., non-relevant information, etc.) and/or identify or highlight other pieces of information (e.g., relevant information associated with relevant events relating to the site 600, etc.).

According to an exemplary embodiment, the workflow 650 includes generating a timeline of the filtered data, shown as generating a timeline of relevant events at step 656. As discussed above, in some embodiments the compiler module 526 is configured to compile (e.g., arrange, organize, etc.) the aggregated (and filtered data) data according to one or more rules or formats, for example to arrange the aggregated (and filtered data) in chronological order. In some embodiments, the compiler module 526 is configured to compile the aggregated data, for example to arrange the aggregated data in chronological order, and the filtering module 528 is configured to filter the aggregated and compiled data to identify relevant events (or data points) along the timeline. In this regard, step 654 and step 656 may be performed in any suitable order. According to an exemplary embodiment, the interface generator module 532 is configured to generate an interface illustrating the timeline or events associated with the site 600. As discussed above, the interface (e.g., timeline) may include one or more indicators, labels, values, and/or displays associated with the events and/or the timeline of the site 600.

According to an exemplary embodiment, the workflow 650 also includes determining characteristics associated with a health of a site, shown as determining an impact of the relevant events on a building health at step 658. For example, the health evaluation module 534 may be configured to receive aggregated data (e.g., aggregated, filtered, compiled data, etc.), and determine one or more characteristics associated with a health of the associated site 600. In some embodiments, the health evaluation module 534 is configured to determine an overall health of an associated site 600. In other embodiments, the health evaluation module 534 is configured to analyze the relevant events, and determine the impact of an identified or isolated event on the overall health of an associated site 600. In other embodiments, the health evaluation module 534 is configured to analyze the relevant events, and determine the impact of an identified or isolated event on an associated component and/or system. As discussed above, in some embodiments the health-related data is communicated to an interface module (e.g., the interface generator module 532), for example to generate an interface illustrating information (e.g., events, impacts, etc.) associated with the health of the site 600. In this regard, in some embodiments step 658 and step 656 may be implemented in any suitable order.

According to an exemplary embodiment, the workflow 650 further includes augmenting the timeline with the characteristics associated with a health of a site, shown as augmenting the timeline with an indicator of building health shown at step 660. For example, the interface augmentor module 536 may be configured to receive health-related data (e.g., from the health evaluation module 534), and augment the timeline (e.g., from step 656) with one or more indicators associated with the health-related data. For example, the interface augmentor module 536 may generate an interface that includes one or more indicators, labels, values, and/or displays, which relate to one or more events associated with a health and/or performance of a site 600. In some embodiments, the interface augmentor module 536 is configured to automatically update the timeline interface (e.g., from step 656). In other embodiments, the interface augmentor module 536 is configured to generate an additional interface, for example to supplement the timeline interface (e.g., from step 656). As discussed above, in other embodiments the interface generator module 532 is configured to receive the health-related data and augment the timeline interface (e.g., from step 656), for example by automatically updating the interface and/or providing an additional interface.

In some embodiments, the workflow 650 further includes causing at least one intervention to affect building health at step 662. Causing the at least one intervention can include executing an automated action that causes a physical intervention at a building site, for example an automated operational change of an equipment unit, a change in a configuration used by a controller to control equipment, a maintenance action implemented on equipment at the building site, a remote service action implemented for a building site, etc., in various embodiments. In some embodiments, step 662 includes automatically generating a work order for a technician to complete a task which is automatically determined to improve building health, for example based one or more predictive maintenance techniques or using generative artificial intelligence, for example as described in U.S. application Ser. No. 18/419,449 filed Jan. 22, 2024 and/or U.S. application Ser. No. 18/759,267, filed Apr. 12, 2023, the entire disclosures of which are incorporated by reference herein. Step 662 can include performing such maintenance. In some embodiments, step 662 includes executing, by equipment of the building site, at least one physical self-repair action to resolve a fault or other improve equipment performance.

As illustrated in FIG. 6, workflow 650 can be executed iteratively following an intervention in step 662. For example, the intervention may be added as an event aggregated in step 652, isolated in step 654, added to a timeline in step 656, assessed for an impact on building health in step 658, such that an impact of the intervention from step 662 can be indicated on the augmented timeline in step 660. Workflow 650 can thereby provide, via an augmented timeline, visible feedback indicative of whether an intervention caused in step 662 has improved, worsened, or otherwise (e.g., substantially not) affected building health. In some scenarios, a timeline generated via iterations of workflow 650 will provide a visualization showing that interventions caused in step 662 provide for improvements in building health, thereby making clear to user viewing the timeline that automatically-driven interventions via workflow 650 are successfully improving and/or maintaining building health.

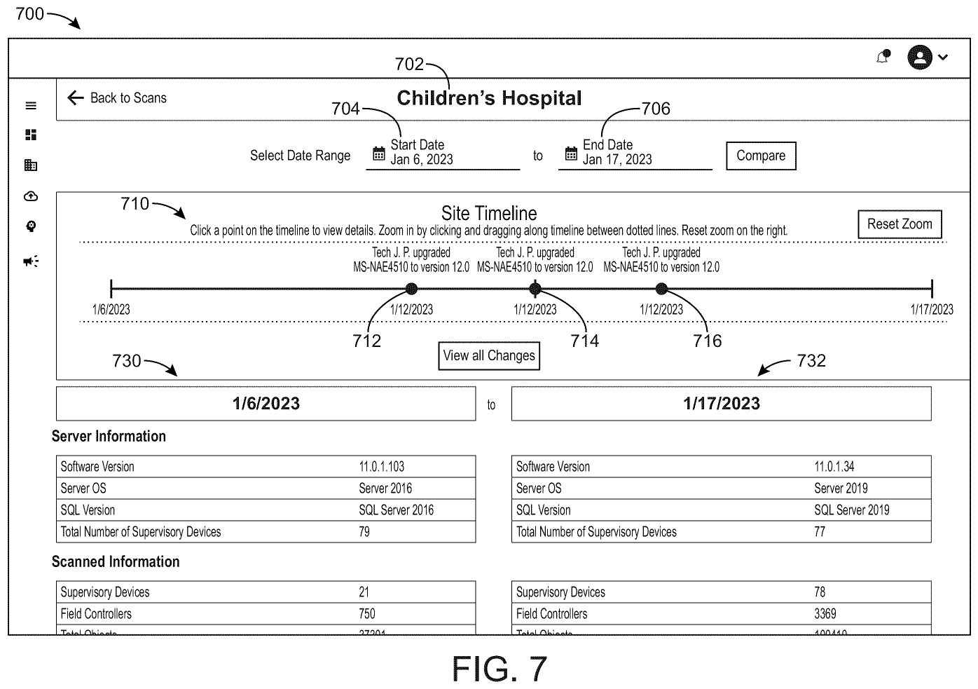

Referring generally to FIGS. 7-16, various interfaces are shown according to exemplary embodiments. The interfaces of FIGS. 7-16 may be generated and/or provided via the components of the site directory tool 500 of FIG. 5, discussed above. Further, the interfaces of FIGS. 7-16 may be generated and/or provided using the site directory workflow 650 of FIG. 6, discussed above. According to an exemplary embodiment, the interfaces of FIGS. 7-16 provide a series of interfaces that display site-related data (e.g., aggregated site-related data, etc.) in an easy to view timeline, such that a user or operator can easily review and/or assess historical events associated with a health and/or performance of a site. Further, the interfaces of FIGS. 7-16 may display health and/or performance related information, which allow a user to easily review and/or assess the health of components or devices at a site, and/or the site overall as a whole, over time. In this regard, the interfaces of FIGS. 7-16 allow a user to review and assess aggregate information from different services and/or features associated with a site over time, in a series of easy to navigate interfaces. Advantageously, the interfaces of FIGS. 7-16 allow a user to review and assess historical information associated with a selected site, aggregated from a plurality of sources, which allows a user to easily understand and quickly (e.g., more efficiently) make service or performance determinations relating to the site.

Referring generally to FIGS. 7-16, the interfaces are shown to include one or more identifiers, indicators, displays, values, signs, markers, and/or other suitable insignia. The indicators may be configured to display and/or present information to a user or viewer. In an exemplary embodiment, a user may interact with (e.g., manipulate, modify, etc.) the indicators and/or one or more features of the interface (e.g., toggles, event markers, etc.), for example to provide input or feedback relating to the information provided via the interface. In some embodiments, the interfaces are updated (e.g., automatically updated, sequentially updated, etc.), for example in response to the user input and/or manipulation. In this regard, the interfaces of FIGS. 7-16 may display and/or communicate a series of information (e.g., relating to a building site) based on a user's input and/or selection of input criteria.

Referring now to FIG. 7, a site timeline interface 700 is shown, according to an exemplary embodiment. The site timeline interface 700 is shown to include a site indicator 702 and a time range display, shown to include a start date input 704 and an end date input 706. The site indicator 702 may provide information (e.g., name, title, unique identifier, etc.) relating to a selected site 600. The start date input 704 and the end date input 706 may be configured to receive inputs (e.g., user input, etc.) relating to a desired start date and a desired end date, respectively. The start date and the end date may indicate a date range to be displayed on the site timeline interface 700, for example relating to events associated with the site 600 (e.g., within the date range).

The site timeline interface 700 is shown to further include a site timeline 710, which may include one or more site event markers, according to an exemplary embodiment. As shown in FIG. 7, the site timeline includes a first event marker 712, a second event marker 714, and a third event marker 716. According to an exemplary embodiment, the event markers provide an indication of relevant events (e.g., service performed, available services or events, etc.) that occurred at the site 600 within the identified date range. As shown, the event markers may include a description of the relevant event and/or a date (and/or time) the relevant event occurred.

The site timeline interface 700 is also shown to include one or more data tables, shown as start date table 730 and end date table 732. According to an exemplary embodiment, the tables 730, 732 are configured to display site-related information associated with different periods in time. For example, the start date table 730 is shown to include information relating to the server (e.g., version, number of supervisory devices, etc.) and scanned devices or systems (e.g., supervisory devices, field controllers, etc.) at the selected start data. Similarly, the end date table 732 is shown to include information relating to the server and scanned devices or systems at the selected end date. In an exemplary embodiment, the tables 730, 732 organize and display site-related information, which allow a user to easily assess changes and/or differences between different periods of time in the lifecycle of the site 600.

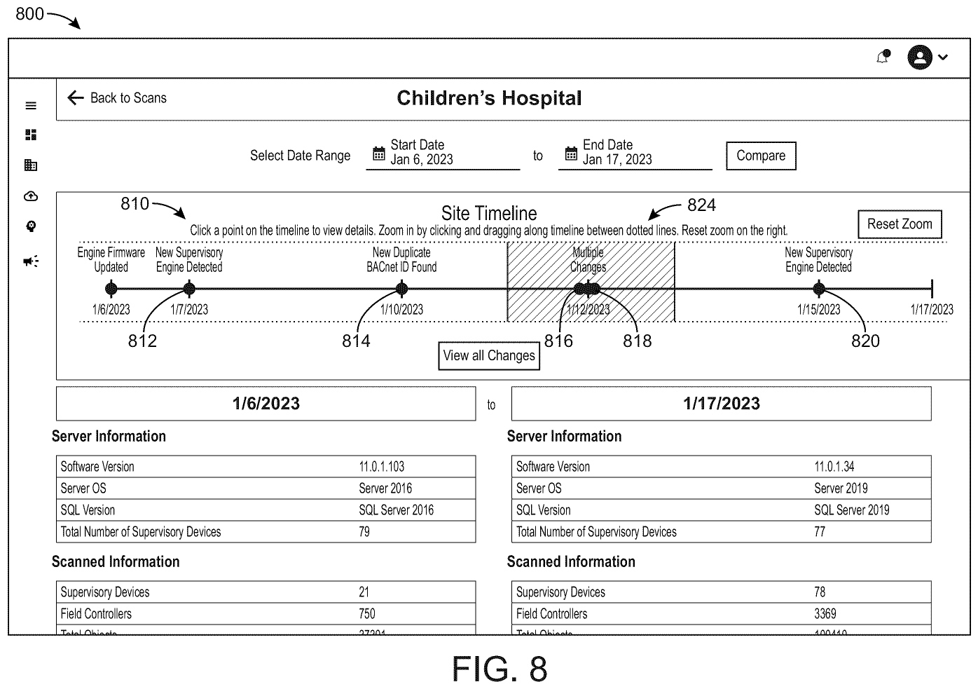

Referring now to FIG. 8, a site timeline interface 800 having a selected time range is shown, according to an exemplary embodiment. Similar to the site timeline interface 700 of FIG. 7, the site timeline interface 800 is shown to include a site timeline 810 having one or more site event markers (e.g., shown as first site event marker 812, second site event marker 814, third site event marker 816, fourth site event marker 818, and fifth site event marker 820). According to an exemplary embodiment, the site timeline interface 800 is also configured to receive an input (e.g., selection, etc.) from a user or operator. For example, as shown in FIG. 8 a user may select a time range within the site timeline 810, shown as range 824. The site timeline interface 800 may display additional information relating to the range 824, for example additional details relating to one or more site events that occurred within the range 824. In some embodiments, the additional details are displayed in one or more tables, for example tables similar to tables 730, 732, discussed above.

In the example shown, the selected time period may be in the past, such that historical events are illustrated. In some embodiments, the site timeline interface 800 (and other interfaces and systems and processes herein) is adapted for selection of a future time period and can provide event indicators for future events, for example planned events (e.g., planned maintenance activities, planned equipment repairs or replacements, planned equipment or software upgrades) or predicted events (e.g., predicted faults, predicted performance degradation, predicted equipment failure, etc.). The teachings herein can thereby be adapted to provide a forward-looking timeline as well as timelines of building events and health over historical time periods.

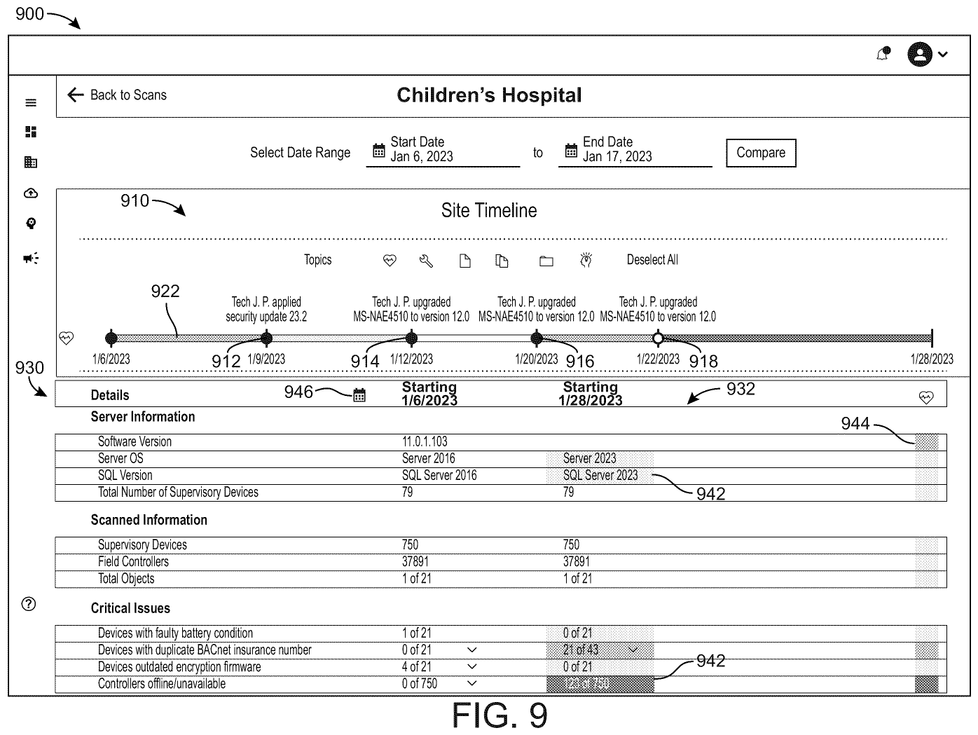

Referring now to FIG. 9, a site timeline interface 900 having health-related information is shown, according to an exemplary embodiment. The site timeline interface 900 is shown to include a site timeline 910 having one or more site event markers (e.g., shown as first site event marker 912, second site event marker 914, third site event marker 916, and fourth site event marker 918). As noted above, the site event markers may include a description of the relevant event and/or a date (and/or time) the relevant event occurred. In some embodiments, the site event markers include additional insignia indicating one or more characteristics relating to the event. For example, as shown in FIG. 9 the fourth site event marker 918 include a numeral. The numeral may indicate the number of events that occurred during that site event. For example, the fourth site event marker 918 (e.g., the number three) may indicate that three scans occurred during that site event.

The site timeline 910 is also shown to include one or more health indicators, shown as health indicator 922. In an exemplary embodiment, the health indicator 922 provides an indication of the overall health of the site 600 at or during an associated time period. For example, the health indicator 922 may include a color (e.g., green, yellow, red, etc.) or label, which represents the overall health of the site 600. In an exemplary embodiment, the health indicator 922 spans between one or more identified events or event markers. For example, as shown in FIG. 9 the site timeline 910 includes a first health indicator 922 (e.g., a yellow health indicator 922) spanning between the start date and the first site event marker 912, a second health indicator 922 (e.g., a light green health indicator 922) spanning tween the first site event marker 912 and the second site event marker 914, a third health indicator 922 (e.g., a dark green health indicator 922) spanning between the second site event marker 914 and the third site event marker 916, etc. In this regard, the health indicator(s) 922 may allow a user to easily review and assess an overall health of the site 600 at or between different events of the lifecycle of the site 600.

The site timeline interface 900 is also shown to include one or more data tables, shown as start date table 930 and end date table 932. As discussed above, the tables 930, 932 may be configured to display site-related information associated with different periods in time (e.g., the start date, the end date, etc.). As shown in FIG. 9, the tables 930, 932 include a change identifier 942. According to an exemplary embodiment, the change identifier 942 identifies (e.g., highlights, etc.) changes between the site-related information between the different periods in time (e.g., the start date, the end date, etc.). The change identifier 942 may also include a color (e.g., green, yellow, red, etc.) or label, for example to indicate the impact the changes had/have on the overall health of the site 600. For example, as shown in FIG. 9 the end date table 932 includes a first change identifier 942 (e.g., a green change identifier 942) indicating a change to the server information, and a second change identifier 942 (e.g., a red change identifier 942) indicating a change to critical issues associated with the site 600. Like the health indicator 922 discussed above, the change identifier(s) 942 may allow a user to easily review changes between selected periods of time (e.g., a selected start date and end date, etc.), and assess the impact the changes have/had on the overall heath of the site 600 over the lifecycle of the site 600.

According to an exemplary embodiment, the tables 930, 932 further include an element health indicator 944. According to an exemplary embodiment, the element health indicator 944 provides an indication of the overall health of one or more elements over an identified time period. For example, the element health indicator 944 may provide an overall health of a software (e.g., via server information), one or more supervisory devices, controllers, etc. over the selected time frame (e.g., between the selected start date and end date). In an exemplary embodiment, the element health indicator 944 may include a color (e.g., green, yellow, red, etc.) or label, which represents the overall heath of the one or more elements.

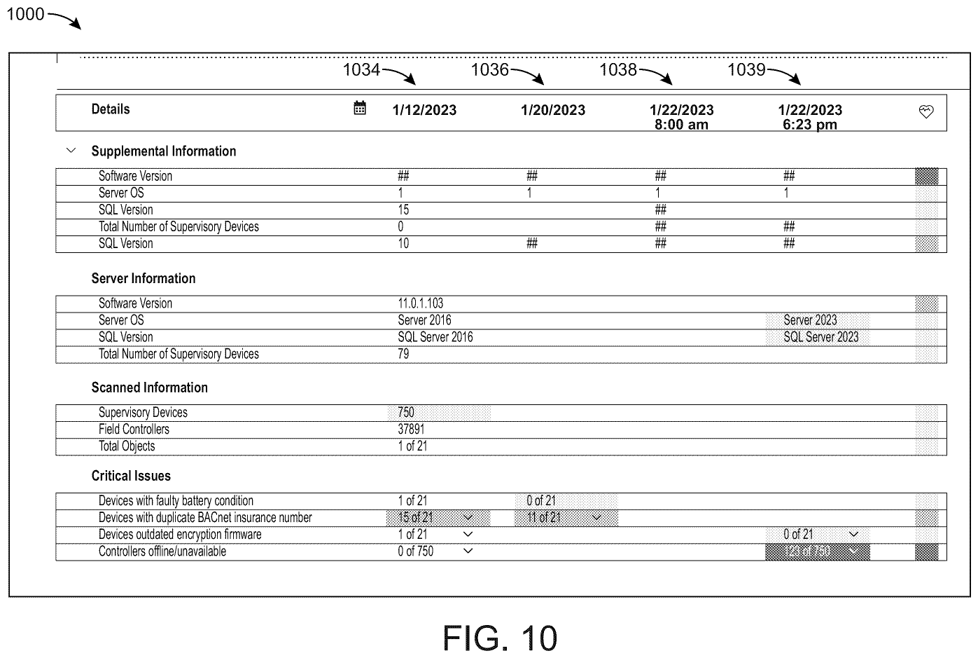

In some embodiments, the site timeline interface 900 (e.g., tables 930, 932, etc.) further includes a date selection icon 946. According to an exemplary embodiment, the date selection icon 946 provides a table or listing, which allows for selection/de-selection of one or more dates (e.g., associated with identified events, etc.) within the identified timeframe. For example, and as shown via interface 1000 in FIG. 10, the date selection icon 946 may allow selection of dates associated with a plurality of dates within the selected timeframe (e.g., a date associated with the second site event, a date associated with the third site event, a data associated with the fourth and fifth site events, etc.). According to an exemplary embodiment, each date may include one or more data tables, for example to display site-related information associated with the different periods of time. As shown in FIG. 10, a first table 1034 may display site-related information at a date of the second site event, a second table 1036 may display site-related information at a date of the third site event, a third table 1038 may display site-related information at a date (and time) of the fourth site event, and a fourth table 1039 may display site-related information at a date (and time) of a fifth site event. As discussed above, the tables 1034-1039 may further include change identifiers (e.g., similar to change identifier 942, etc.) and/or element health indicators (e.g., similar to element health indicator 944, etc.), which provide an indication of changes and/or heath between events over the course of the identified timeframe.

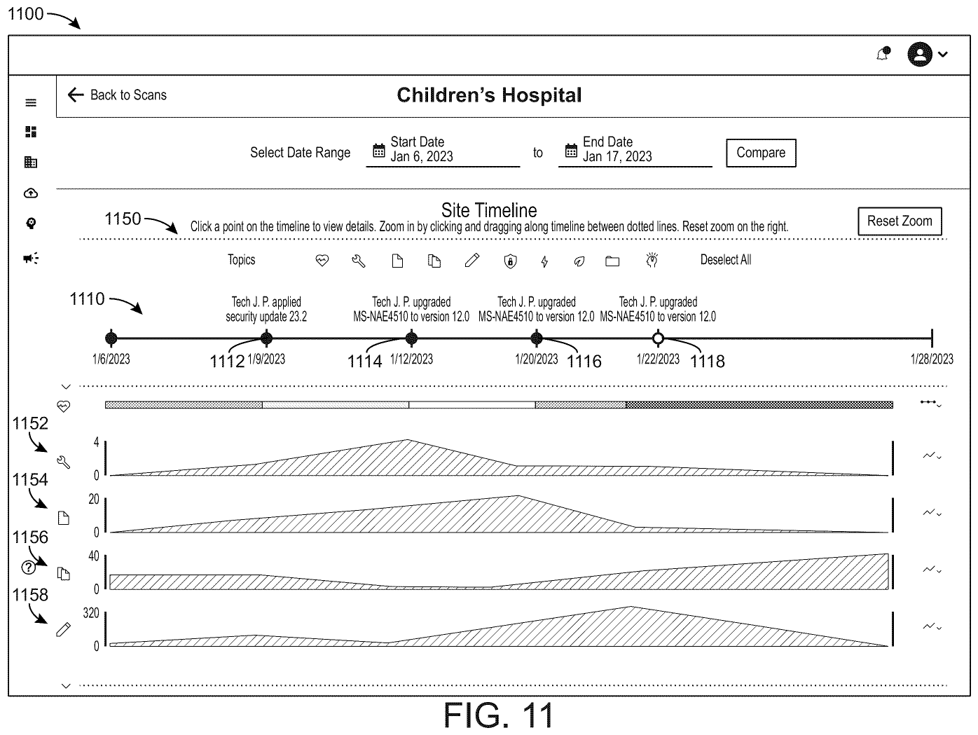

Referring now to FIG. 11, a site timeline interface 1100 having topic information is shown, according to an exemplary embodiment. The site timeline interface 1100 is shown to include a site timeline 1110 having one or more site event markers (e.g., shown as first site event marker 1112, second site event marker 1114, third site event marker 1116, and fourth site event marker 1118). According to an exemplary embodiment, the site timeline interface 1100 further includes a topic selection bar 1150, having one or more topic selection icons. For example, the topic selection bar 1150 may include one or more topic selection icons relating to one or more services and/or features associated with the site 600. The services or features (e.g., topic selection icons) may include site health, service visits, work orders completed, work orders added, changes made to the system, information related to cybersecurity, and/or other information relating to services and/or features associated with the site 600. According to an exemplary embodiment, the topic selection icons are configured to be selected/de-selected, for example to display/obscure additional topic related information on the site timeline interface 1100.

According to an exemplary embodiment, the site timeline interface 1100 includes one or more topic report displays. The topic report displays may be configured to provide information relating to events or occurrences associated with one or more topics, for example over the course of the selected timeframe. As shown in FIG. 11, the site timeline interface 1100 includes a service report graph 1152, a ticket report graph 1154, a work order graph 1156, and a system changes graph 1158. According to an exemplary embodiment, the service report graph 1152 provides a visualization of the number of service visits performed at the site 600 over the course of the selected timeframe (e.g., between the selected start date and end date, between each of the identified site events, etc.). The ticket report graph 1154 may provide a visualization indicating the number of tickets that were closed over the course of the selected timeframe, and the work order graph 1156 may provide a visualization of the number of open work orders at the site 600 over the selected timeframe. Further, the system changes graph 1158 may provide a visualization of the number of system changes associated with the site 600 over the selected timeframe. Although the topic report displays are shown and described herein as being graphs, in other embodiments the topic report displays are other displays suitable for visually providing information relating to the different topics (e.g., a line graph, bar chart, timeline, etc.).

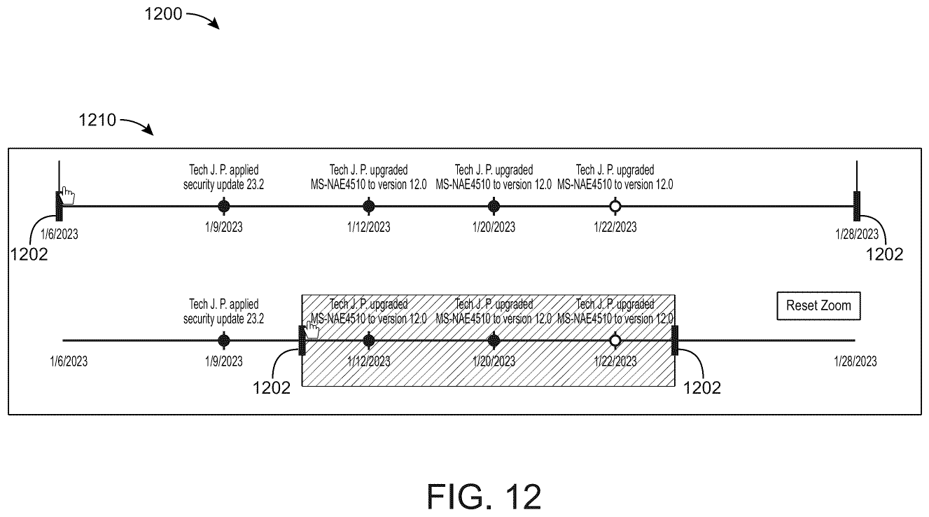

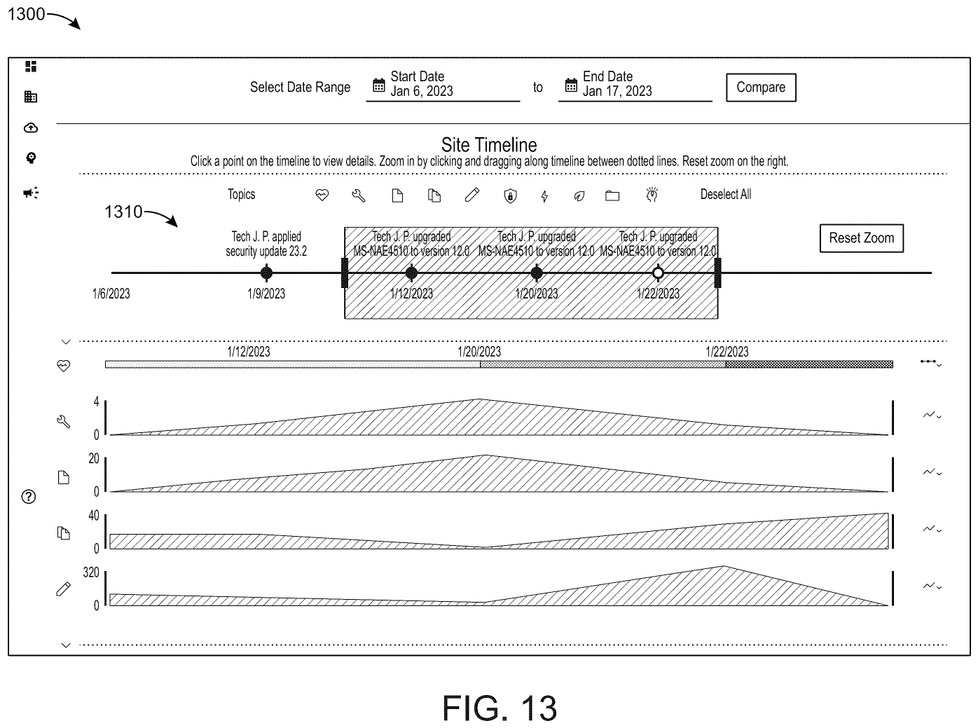

Referring now to FIGS. 12-13, site timeline interfaces having at least one timeline adjuster is shown, according to an exemplary embodiment. According to an exemplary embodiment, a site timeline interface 1200 displays one or more site events on a site timeline 1210 between a first time period (e.g., an identified start date) and a second period (e.g., an identified end date). As shown in FIG. 12, the site timeline interface 1200 includes one or more adjusters or scrubbers, shown as adjusters 1202. According to an exemplary embodiment, the adjuster 1202 is movable (e.g., along the site timeline 1210), for example to adjust one or more selected time periods of the site timeline 1210. For example, the adjuster 1202 may be movable to change the first time period (e.g., the identified start date) and/or to change the second time period (e.g., the identified end date). As shown in FIG. 12, the adjusters 1202 may be adjusted or modified, so as to change the timeframe of the site timeline 1210 (e.g., the start date, the end date, etc.). According to an exemplary embodiment, the adjusted site timeline of FIG. 12 may be displayed, for example as an adjusted site timeline 1310 shown in site timeline interface 1300 of FIG. 13. In an exemplary embodiment, the site timeline interface 1300 and/or the adjusted site timeline 1310 includes similar features as the site timeline interfaces 700-1000 discussed with reference to FIGS. 7-10 (e.g., one or more site event markers, tables, topic report displays, etc.).

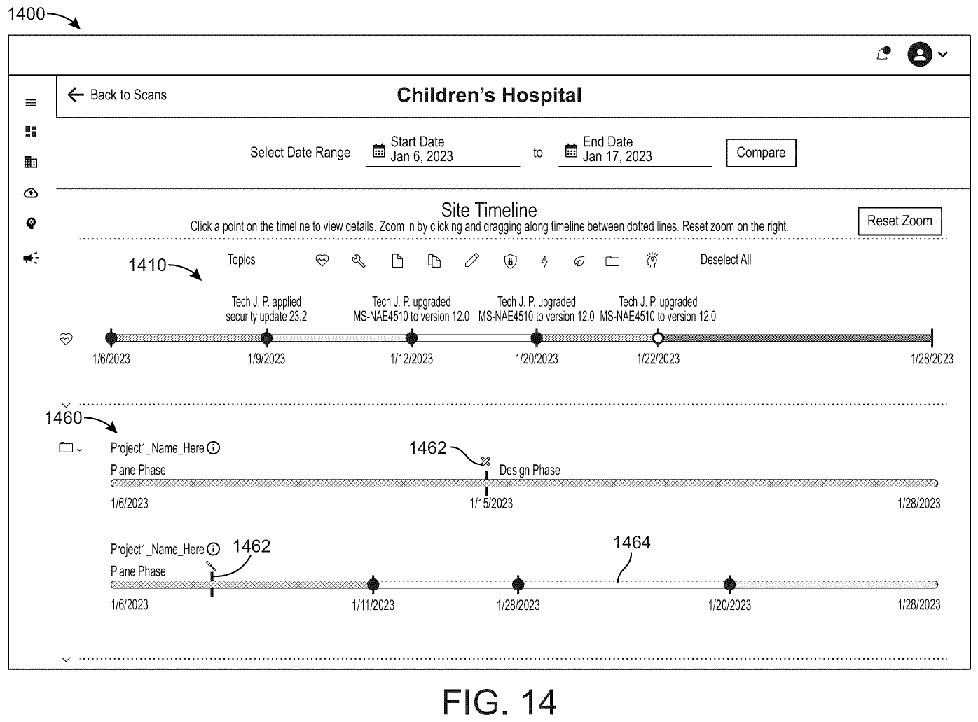

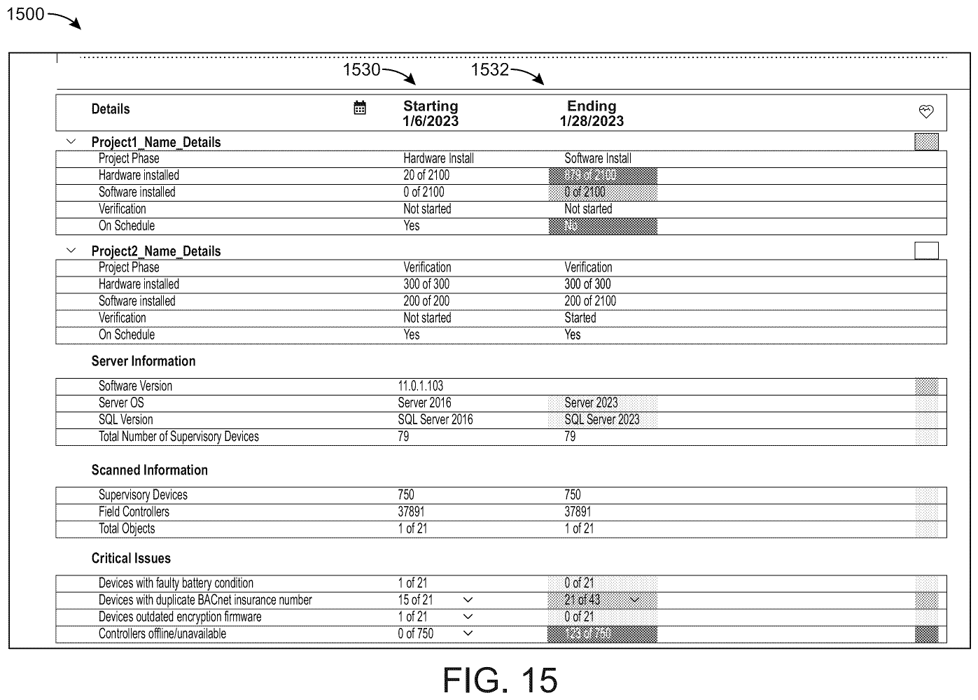

Referring now to FIGS. 14-15, interfaces having project information are shown, according to an exemplary embodiment. According to an exemplary embodiment, a site timeline interface 1400 (as shown in FIG. 14) includes a site timeline 1410 having one or more site event markers, as discussed above. According to an exemplary embodiment, the site timeline interface 1400 further includes one or more project timelines, shown as project timeline 1460. According to an exemplary embodiment, the project timeline 1460 and the site timeline 1410 are displayed across the same timeframe (e.g., between the selected start date and end date).

As shown in FIG. 14, the project timeline 1460 includes one or more phase indicators 1462. The phase indicator 1462 may provide an indication of the phase of a point in time along the project timeline 1460. For example, the phase indicator 1462 may include an annotation or marking, indicating that a period of time is at a plan phase, a design phase, an install phase, a commission phase, a verification phase, a service phase, etc. in the project timeline 1460. In some embodiments, the phase indicator 1462 indicates transition between one or more phases in the project timeline 1460. For example, and as shown in FIG. 14, the phase indicator 1462 may indicate a transition between the plan phase and design phase along the project timeline 1460, or a transition between the design phase and the install phase along the project timeline 1460. According to an exemplary embodiment, the project timeline 1460 further includes a status indicator 1464. According to an exemplary embodiment, the status indicator 1464 includes a color (e.g., green, yellow, red, etc.), for example to represent the project timeline 1460 relative to a predetermined timeline (e.g., a projected timeline, an optimal timeline, an anticipated timeline, etc.). In this regard, the status indicator 1464 may be configured to indicate the status of the project timeline 1460 compared to an intended or projected schedule or timeline.

According to an exemplary embodiment, additional information or details relating to one or more aspects of the project timeline 1460 can also be displayed. As shown in FIG. 15, an interface 1500 illustrating details relating to one or more project timelines (e.g., the project timelines 1460 of FIG. 14) can be displayed in one or more tables, shown as table 1530 and table 1532. As noted above, the tables 1530, 1532 may display site-related information associated with different periods of time (e.g., a start date, an end date, etc.). According to an exemplary embodiment, the tables 1530, 1532 further include change identifiers (e.g., similar to change identifier 942, etc.) and/or element health indicators (e.g., similar to element health indicator 944, etc.), which provide an indication of changes and/or heath between events over the course of the identified timeframe.

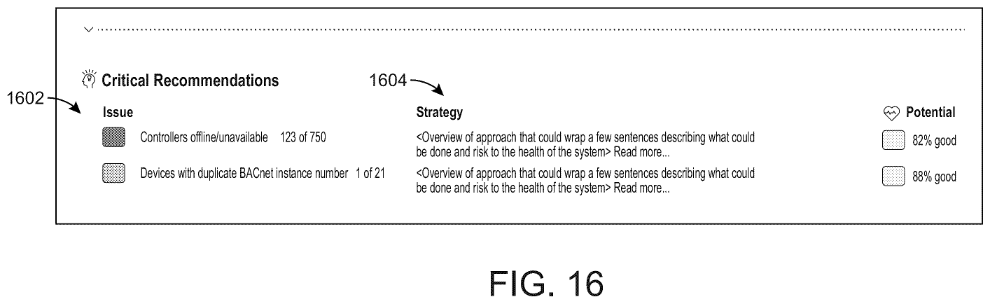

Referring now to FIG. 16, a recommendation interface 1600 is shown, according to an exemplary embodiment. In an exemplary embodiment, the recommendation interface 1600 is implemented or integrated with any and/or all of the interfaces 700-1500 of FIGS. 7-15. As shown in FIG. 16, the recommendation interface 1600 includes an issue identification icon 1602, a recommendation display 1604, and a health potential indicator 1606. According to an exemplary embodiment, the issue identification icon 1602 provides an indication of an identified issue or potential issue associated with the site 600. The issue identification icon 1602 may include a color (e.g., green, yellow, red, etc.), for example to represent the severity of the identified issue. Further, the issue identification icon 1602 may include a label or text, for example to provide a description of the identified issue. The recommendation display 1604 is shown to include a label or text, for example to provide an overview of the issue and/or a recommended approach for actions or measures that could be taken to remediate the issue. In some embodiments, the recommendation display 1604 further includes information (e.g., text, description, etc.) relating to how the issue may impact the overall health of the site 600 and/or the associated device or system. In an exemplary embodiment, the health potential indicator 1606 provides an indication of the potential impact of remedial measures (e.g., provided via the recommendation display 1604) on the overall health of the site 600.

According to an exemplary embodiment, the features described herein advantageously allow reception of data from one or more different data sources (e.g., salesforce, business solutions, software applications, etc.), aggregate the data from the data sources, unify the data into a unified format, and/or provide the data in one or more adaptable interfaces that allow a user to easily view and/or assess events associated with the health and/or performance of a building site. The interfaces described herein may be configured to allow a user or viewer to easily see changes and/or trends in historic health information of a building site or system (e.g., via a rating system, etc.). Further, the interfaces allow a user or viewer to quickly visualize and/or assess the impact of specific changes or activities (e.g., on the associated device or component, or on the overall health of the building site). Yet further, the components described herein offer the ability to create interfaces that provide real-time data visualization illustrating changes over time, which provide valuable information associated with performance metrics, service tickets, key performance indicators, and/or other integrated building management system data or components (e.g., building system “topics,” etc.). According to an exemplary embodiment, the components described herein also are configured to generate and/or provide recommendations based on identified events (e.g., issues, etc.), for example to facilitate implementing corrective actions, evaluate the potential impact of the identified event on the overall health of the site, and/or evaluate the impact on the overall health of the site if the recommended corrective actions are implemented.

In this regard, the teachings herein also advantageously reduce computational complexity, computational complexity, and network bandwidth associated with digital display of information relating to multiple building applications spanning a building site lifecycle. Without the teachings herein, a user computing device would need to separate launch and/or access multiple separate building applications (consuming computer-short term memory, network bandwidth, etc.), provide, for each separate application, interactions (e.g., displaying multiple user interfaces for the multiple applications) capable of navigating to a system of interest, providing separate queries for and loading of relevant data in the different application systems (e.g., from cloud services provided for the different applications), etc. If such information is to be presented simultaneous, as contemplated by the solutions herein, a need would exist for a large display and/or multiple displays or user devices to display the multiple different applications simultaneously (e.g., different windows, different apps, different display screens, etc.). All such operations are eliminated by the teachings herein which provide for an efficient aggregation and filtering of events from multiple separate applications such that a unified timeline showing relevant events for a building site is provided via an interface. Computer operations for providing such an unified timeline are thus greatly reduced in complexity, memory requirements, computational load, computing time, etc. as compared to the scenario described above without the teachings herein, where many separate applications much be launched to even approximate the information delivery of the present application. In this regard, it should also be understood that the aggregation and processing of data into a predetermined data format from separate applications that use different formats and using a table of site directory associations contributes to the computational and data storage efficiencies of the teachings here as compared to alternative approaches.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. For example, the recommendation interface 1600 of the exemplary embodiment described in FIG. 16 may be incorporated in the site timeline interface 900 of the exemplary embodiment described in FIG. 9. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method, comprising:
receiving data relating to a building site from a plurality of separate building applications;
aggregating the received data from the plurality of separate building applications in accordance with a predetermined format, wherein the aggregated data represents a plurality of events associated with the building site over a lifecycle of the building site;
filtering the aggregated data to identify a plurality of isolated events associated with the building site over the lifecycle of the building site, wherein each of the plurality of isolated events includes a time associated with the isolated event;
generating a timeline comprising the plurality of isolated events, wherein the timeline is arranged based on the time associated with each isolated event; and
providing the timeline on a graphical user interface, wherein each of the plurality of isolated events includes an event marker on the timeline representative of the isolated event.

2. The method of claim 1, wherein receiving the data relating to the building site from the plurality of separate building applications includes receiving data from two or more of a commissioning application, a service application, a sales management application, a business solutions application, and a performance verification tool.

3. The method of claim 1, wherein receiving the data relating to the building site from the plurality of separate building applications includes receiving data arranged in one or more different data formats.

4. The method of claim 3, further comprising converting, via one or more conversion rules, the received data from the plurality of separate building applications into a unified data format.

5. The method of claim 3, wherein aggregating the received data from the plurality of separate building applications in accordance with the predetermined format includes generating a table, the table including associations between building site identifiers of the one or more different data formats and a unified building site identifier.

6. The method of claim 1, wherein filtering the aggregated data to identify the plurality of isolated events includes obscuring additional events associated with the building site over the lifecycle of the building site such that the plurality of isolated events provide an overall view of the lifecycle of the building site.

7. The method of claim 1, wherein filtering the aggregated data to identify the plurality of isolated events includes filtering the aggregated data using a machine learning model trained using historical data associated with a plurality of building sites.

8. The method of claim 1, wherein filtering the aggregated data to identify the plurality of isolated events includes filtering the aggregated data using a plurality of filtering rules, wherein each of the plurality of filtering rules is associated with a different building application of the plurality of separate building applications.

9. The method of claim 1, further comprising generating, via an artificial intelligence (AI) model trained using historical data associated with a plurality of building sites, an additional event and a time associated with the additional event to be included in the timeline.

10. The method of claim 9, wherein providing the timeline on the graphical user interface includes providing the additional event with an event marker that is different than the event markers of the plurality of isolated events.

11. The method of claim 9, further comprising receiving an approval of the additional event from a user, and updating the timeline on the graphical user interface to include the additional event on the timeline.

12. The method of claim 1, wherein providing the timeline on the graphical user interface includes providing the timeline with a health indicator, wherein the health indicator provides an indication of an overall health of the building site at a point in time along the timeline.

13. The method of claim 1, wherein providing the timeline on the graphical user interface comprises providing a table associated with one or more points in time along the timeline, wherein the table includes characteristics relating to a component of the building site at a first point in time along the timeline and a second point in time along the timeline; and
wherein providing the table associated with the one or more points in time along the timeline comprises:
providing a change identifier, the change identifier indicating a change in the characteristic of the component of the building site between the first point in time and the second point in time; and
providing an element health indicator, the element health indicator providing an indication of an overall health of the component of the building site between the first point in time and the second point in time.

14. The method of claim 1, wherein providing the timeline on the graphical user interface includes providing a topic selection bar including a plurality of topic selection icons, and wherein in response to a selection of one or more of the plurality of topic selection icons the method further comprises providing one or more topic report displays, wherein providing the one or more topic report displays includes providing one of a service report graph indicating a number of service visits performed at the building site over the timeline, a ticket report graph indicating a number of tickets close over the timeline, a work order graph indicating a number of open work orders over the timeline, and a system change graph indicating a number of system changes associated with the building site over the timeline.

15. The method of claim 1, wherein providing the timeline on the graphical user interface includes providing a project timeline associated with a project at the building site, the project timeline including a phase indicator indicating a phase of the project at a point in time along the project timeline, wherein providing the project timeline includes providing a status indicator, the status indicator indicating a status of the project compared to a projected timeline associated with the project.

16. The method of claim 1, further comprising providing a recommendation interface on the graphical user interface, wherein the recommendation interface includes an issue identification icon designating an identified issue, a recommendation display including a recommendation for addressing the identified issue, and a health potential indicator providing an indication of a projected overall health of the building site based on the recommendation.

17. The method of claim 1, further comprising automatically causing, based on the data relating to the building site, an intervention at the building site to affect building health and adding the intervention to the timeline on the graphical user interface.

18. One or more non-transitory computer-readable media storing program instructions that, when executed by one or more processors, cause the one or more processors to perform operations comprising:
receiving data relating to a building site from a plurality of separate building applications;
aggregating the received data from the plurality of separate building applications in accordance with a predetermined format, wherein the aggregated data represents a plurality of events associated with the building site over a lifecycle of the building site;
filtering the aggregated data to identify a plurality of isolated events associated with the building site over the lifecycle of the building site, wherein each of the plurality of isolated events includes a time associated with the isolated event;
generating a timeline comprising the plurality of isolated events, wherein the timeline is arranged based on the time associated with each isolated event; and
providing the timeline on a graphical user interface, wherein each of the plurality of isolated events includes an event marker on the timeline representative of the isolated event.

19. The one or more non-transitory computer readable media of claim 18, wherein the operations further comprise automatically causing, based on the data relating to the building site, an intervention at the building site to affect building health and adding the intervention to the timeline on the graphical user interface.

20. A building system comprising:
building equipment operable to heat, cool, or ventilate a building;
a plurality of computing system providing a plurality of building applications comprising two or more of a commissioning application, a service application, a sales management application, a business solutions application, and a performance verification tool; and
a site directory tool comprising circuitry programmed to:
receive data relating to a building site from the plurality of building applications;
aggregate the received data from the plurality of building applications in accordance with a predetermined format, wherein the aggregated data represents a plurality of events associated with the building site over a lifecycle of the building site;
filter the aggregated data to identify a plurality of isolated events associated with the building site over the lifecycle of the building site, wherein each of the plurality of isolated events includes a time associated with the isolated event;
generate a timeline comprising the plurality of isolated events, wherein the timeline is arranged based on the time associated with each isolated event; and
provide the timeline on a graphical user interface, wherein each of the plurality of isolated events includes an event marker on the timeline representative of the isolated event.
